(19) United States
(12) Patent Application Publication
(10) Pub. No.: US 2024/0402566 A1
(43) Pub. Date: Dec. 5, 2024

(54) Wavelength Conversion Apparatus

(71) Applicant: Nippon Telegraph and Telephone Corporation, Tokyo (JP)

(72) Inventors: Yuji Fujiwara, Musashino-shi, Tokyo (JP); Kei Watanabe, Musashino-shi, Tokyo (JP); Takushi Kazama, Musashino-shi, Tokyo (JP)

(21) Appl. No.: 18/691,392

(22) PCT Filed: Oct. 14, 2021
(86) PCT No.: PCT/JP2021/038113

§ 371 Date: Mar. 12, 2024

(51) Int. Cl. G02F 1/35

(52) U.S. Cl. CPC G02F 1/3501; G02F 2201/58; G02F 2203/055; G02F 2203/48

(57) ABSTRACT

A wavelength conversion device is provided with a wavelength converter using a non-linear optical medium and a controller that controls a temperature of the wavelength converter, in which the wavelength converter includes an input port to which signal light and excitation light are input, a gain equalizer having at least one input port and two or more output ports is connected to an output (subsequent stage) of the wavelength converter, light output from the wavelength converter is input to the gain equalizer, the light is split into gain-equalized light and other light, then the split other light is measured by a light intensity detector, and the temperature of the wavelength converter is controlled by the controller on the basis of detected light intensity. The gain equalizer selectively splits only unnecessary light out of the light output from the nonlinear optical element, so that an excessive loss can be suppressed.

### TECHNICAL FIELD

The present invention relates to a wavelength conversion device using a non-linear optical medium, and more particularly to temperature control of the wavelength conversion device.

### BACKGROUND ART

In this type of wavelength conversion device, since the refractive index of the non-linear optical medium has temperature dependency, it is desirable to keep the temperature of the wavelength conversion device constant. As a result, a quasi-phase matching condition in the wavelength conversion device that is the second-order non-linear optical element can be satisfied.

Patent Literature 1 proposes a technique of branching a part of light after wavelength conversion using an optical branch coupler at a stage subsequent to a wavelength conversion device, estimating an actual temperature of a waveguide from a spectral shape thereof, and adjusting the temperature of the wavelength conversion device.

### CITATION LIST

### Patent Literature

Patent Literature 1: JP 2020-76834 A

### SUMMARY OF INVENTION

However, in Patent Literature 1, since the temperature control of the wavelength conversion device is performed on the basis of the light branched using the optical branch coupler, there is a problem that the loss of the conversion light is increased by the branched light. That is, it is necessary to branch a certain degree of optical power of the temperature control light in order to secure the S/N at the time of receiving light, and the branched light is directly lost. Therefore, for example, in a case where this method is applied to an optical device for optical communication, the level of the amplified signal is lowered.

An object of the present invention is to provide a wavelength conversion device using a non-linear optical medium capable of suppressing excessive loss due to optical branching for the purpose of control.

In order to achieve such an object, an embodiment of the present invention is a wavelength conversion device including a wavelength converter using a non-linear optical medium and a controller that controls a temperature of the wavelength converter, the wavelength conversion device including: a Gain EQualizer (GEQ) that inputs light generated by parametric fluorescence in the wavelength converter; and a wavelength separation filter that separates light of one or more wavelengths from light branched by the GEQ, in which the controller controls the temperature of the wavelength converter based on a difference in light intensity of the one or more lights.

According to the present invention, since the temperature of the wavelength converter is controlled on the basis of the difference in the light intensity of the light branched by the gain equalization processing by the GEQ, it is possible to suppress the loss of the light converted by the wavelength converter.

### BRIEF DESCRIPTION OF DRAWINGS

FIG. 1 is a diagram illustrating a configuration of a wavelength conversion device according to Example 1 of the present invention.

FIG. 2 is a diagram illustrating a relationship between frequencies of excitation light, signal light, and conversion light.

FIG. 3 is a diagram illustrating a state of a change in a wavelength conversion band with respect to a change in an operating temperature.

FIG. 4 is a diagram illustrating wavelength dependency of transmittance of a Through port of GEQ.

FIG. 5 is a diagram illustrating that light having two peaks is output on a spectrum.

FIG. 6 is a graph illustrating operating temperature dependency of the wavelength converter on a difference in optical power from 1546 nm in a case of selecting 1560 nm and 1595 nm for one wavelength.

FIG. 7 is a graph in which a gradient of the operating temperature dependency of the difference between the optical powers of the two wavelengths is plotted for each wavelength.

FIG. 8 is a diagram illustrating a configuration of a wavelength conversion device according to Example 2 of the present invention.

FIG. 9 illustrates a configuration of a wavelength conversion device in which a GEQ and an AWG are integrated on one chip.

FIG. 10 is a diagram illustrating a result of acquiring a gradient of operating temperature dependency of a difference between optical powers of two wavelengths by changing a bandwidth of an AWG.

FIG. 11 is a diagram illustrating a configuration of a wavelength conversion device according to Example 3 of the present invention.

FIG. 12 is a diagram illustrating another configuration of the wavelength conversion device according to Example 3 of the present invention.

FIG. 13(a) is a diagram illustrating wavelength dependency of transmittance of a Through port of a coupler of a conventional example. FIG. 13(b) is a diagram illustrating that light having two peaks is output on a spectrum of a conventional example. FIG. 13(c) is a reduced view of FIG. 4. FIG. 13(d) is a reduced view of FIG. 5.

### DESCRIPTION OF EMBODIMENTS

Hereinafter, examples of the present invention will be described in detail with reference to the drawings. The embodiment described below exemplifies a specific embodiment of the present invention. Therefore, the configuration of the examples described below should be appropriately modified or changed depending on the configuration of the device to which the present invention is applied and various conditions, and the present invention is not limited to the following examples.

### Example 1

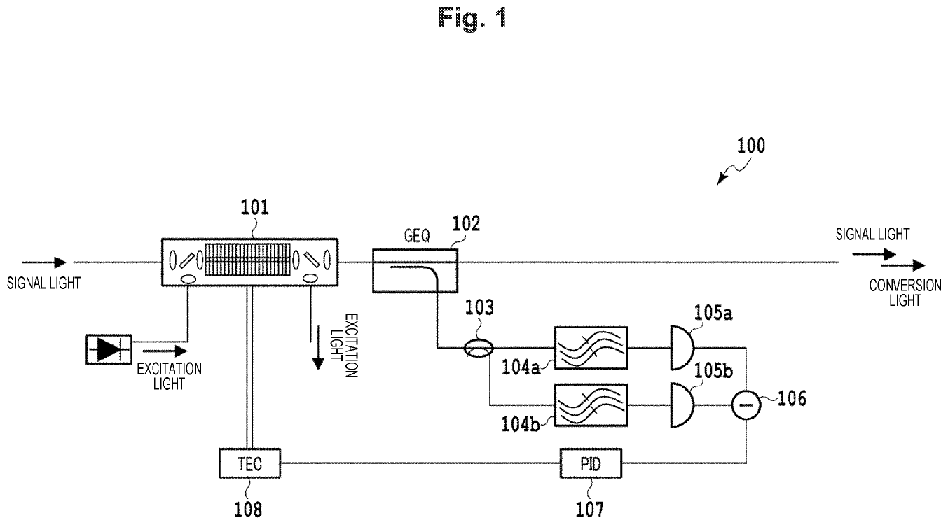

FIG. 1 is a block diagram illustrating a configuration of a wavelength conversion device 100 according to Example 1. An output signal from a wavelength converter 100 is input to a gain equalizer (GEQ) 102. The GEQ 102 performs gain equalization processing on the input signal, and outputs the gain-equalized light as conversion light of the WDM signal light and the WDM signal. This light is used for, for example, optical communication. The GEQ 102 also outputs light that is excessive by the gain equalization processing. That is, the optical signal input to the GEQ 102 is branched into signal light, conversion light, and excess light in the GEQ 102.

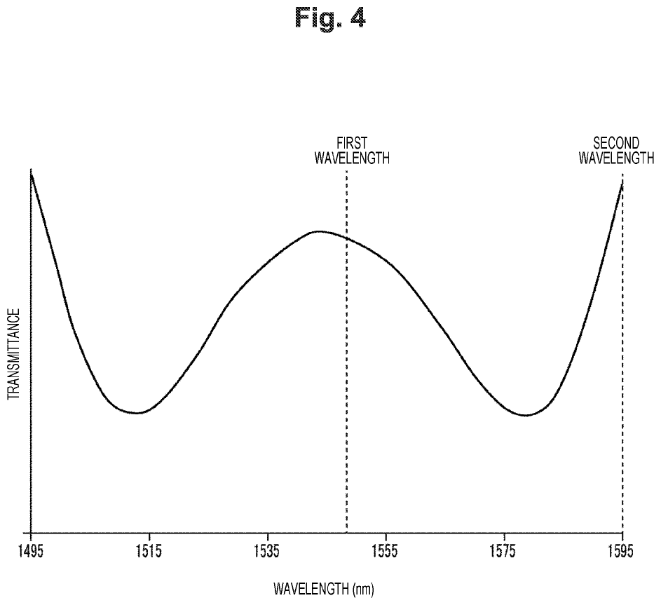

The branched excess light is branched into two light beams by an optical branch coupler (3 dB coupler) 103. Then, the light branched by the optical branch coupler 103 is input to a first wavelength separation filter 104a and a second wavelength separation filter 104b, respectively. As will be described later with reference to FIG. 4 and the like, light of two wavelengths is separated (extracted) from the excess light by the two separation filters. Then, the outputs of the first wavelength separation filter 104a and the second wavelength separation filter 104b are input to a first light intensity detector (first photodiode) 105a and a second light intensity detector (second photodiode) 105b, respectively, and a difference value is obtained for each obtained light altitude by a differentiator 106. As will be described later, the difference in the light intensity is output to a proportional integral differential (PID) 107 as temperature information of the wavelength converter 100. A thermoelectric controller (TEC) 108 is thermally coupled to the wavelength converter 101, and the thermoelectric controller 108 controls the temperature of the wavelength converter 101 based on temperature information indicated by a control current from the controller 107. The thermoelectric controller 108 of the present embodiment performs temperature adjustment to maintain the wavelength converter 101 at a predetermined temperature suitable for its operation.

The wavelength converter 101 includes a lithium niobate (PPLN) waveguide having a periodically polarization-inverted structure that satisfies quasi-phase matching between signal light and excitation light to be input and conversion light to be output, a dichroic mirror type multiplexer that multiplexes the signal light and the excitation light and inputs the multiplexed signal light and excitation light to the PPLN waveguide, and a dichroic mirror type demultiplexer that demultiplexes the excitation light from an output of the PPLN waveguide. As the wavelength converter 101, a non-linear optical medium containing LiNbO₃, LiTaO₃, LiNb(x)Ta(1-x)O₃ (0≤x≤1), or at least one selected from the group consisting of Mg, Zn, Sc, and In as an additive thereof is used.

Next, the operation of the wavelength conversion device 100 of Example 1 will be described with the functions of the respective units. As signal light to be input to the wavelength converter 101, an optical signal having a plurality of wavelengths is input. In Example 1, a wavelength multiplex signal (WDM signal) is input. In the wavelength converter 101, the dichroic mirror type multiplexer multiplexes the WDM signal and the excitation light from the excitation light source and enters the wavelength converter 101. The wavelength converter 101 generates conversion light of a WDM signal by difference frequency generation (DFG).

Assuming that the frequency of the excitation light is 2ω₀ and the frequency of one wavelength of the WDM signal is @s, conversion light having a frequency of 2ω₀−ωₛ is generated by generation of a difference frequency in the wavelength converter 101. As the optical phase, when the phase of the excitation light is set to Φₚ and the phase of the signal light is set to Φₛ, Φₚ−Φₛ is obtained by the generation of the difference frequency, and the phase conjugate light of the signal light is generated with the phase of the excitation light as a reference. When a wavelength (frequency: Φ₀) that is twice the wavelength of the excitation light is defined as a fundamental wavelength, the plurality of signal light beams included in the WDM signal are generated as conversion light beams having a wavelength obtained by folding back the fundamental wavelength as a central wavelength axis. At the same time as the conversion light is generated, energy is also transferred from the excitation light to the WDM signal, and the signal light is amplified.

The conversion light generated by the wavelength converter 101 is output to the dichroic mirror type demultiplexer together with the WDM signal obtained by multiplexing the excitation light. The dichroic mirror type demultiplexer separates the excitation light from the light output from the PPLN waveguide, and outputs the separated light (amplified WDM signal+conversion light of the WDM signal) as output light of the wavelength converter 101.

The wavelength converter serves as the wavelength converter 101 and the phase conjugate converter in a case of extracting “conversion light of the WDM signal”, and serves as an optical parametric amplifier in a case of extracting “amplified WDM signal light”.

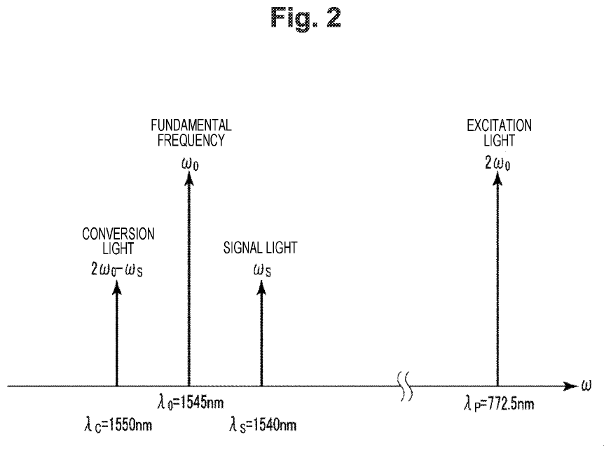

FIG. 2 illustrates a relationship between frequencies of the excitation light, the signal light, and the conversion light. The wavelength conversion band of the wavelength converter 101 in a case where the fundamental wavelength λ₀ (frequency: ω₀) is 1545 nm and the excitation light wavelength λₚ (frequency: 2ω₀) is 772.5 nm will be described. Note that the element length of the PPLN waveguide was 42 mm. By inputting the excitation light and the signal light, the conversion light is generated by the difference frequency generation of the wavelength converter 101. For example, as illustrated in FIG. 2, assuming that the signal light wavelength λₛ (frequency: ωₛ) is 1540 nm, the conversion light having the wavelength λ_{c} of 1550 nm is generated by 2ω₀−ωₛ. The conversion light is generated in a form folded back on the wavelength axis around the fundamental wavelength λ₀.

In the wavelength converter 101, the quasi-phase matching condition is satisfied among three waves of the excitation light, the signal light, and the conversion light. Assuming that effective refractive indexes of the excitation light, the signal light, and the conversion light in the waveguide are np, ns, and nc, respectively,
a polarization-inverted structure with an inversion period Λ satisfying

$$np / λ p - n s / λ s - nc / λ c = 1 / Λ \qquad ( Equation 1 )$$

is provided.

As long as (Equation 1) is satisfied, even if the signal light wavelength is changed, the same conversion efficiency can be obtained between the conversion light having the frequency 2ω₀−ωₛ and the excitation light. For example, if the signal light wavelength λₛ (frequency: ωₛ) is 1539 nm, conversion light having a wavelength of 1551 nm is generated by 2ω₀−ωₛ. At this time, although the effective refractive indexes nₛ and n_{c} also change, there is an advantage that (Equation 1) can be satisfied and a wide wavelength conversion band can be obtained even if the signal light wavelength is changed by decreasing the amount n_{c} by which nₛ increases due to dispersion of the material.

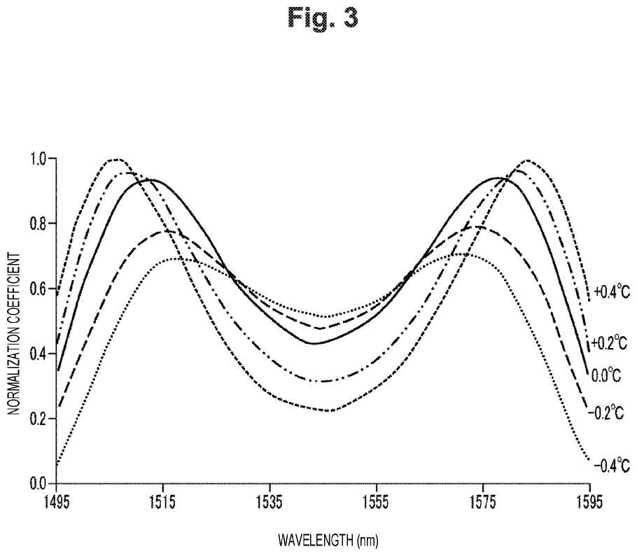

FIG. 3 is a diagram illustrating how the wavelength conversion band changes with respect to the change in the operating temperature, and illustrates, for each temperature change, a value obtained by normalizing the light intensity (optical power) of the wavelength conversion band under the above-described conditions with reference to the optical power when the temperature change is 0° C. As described above, while the optical power fluctuates with respect to the temperature change, a method of optimizing the operating temperature by monitoring one conversion light of the WDM signal is considered. However, since the temperature dependence of the optical power varies depending on the wavelength of the conversion light, it is not clear whether it is simply necessary to increase or decrease the temperature. In addition, a method of optimizing the operating temperature by monitoring all the conversion light is also conceivable, but control processing becomes complicated and the number of components for the control processing becomes large. In addition, when the power of the input signal light fluctuates, the conversion light power fluctuates as it is, and thus, the control becomes more complicated on the premise of the input from the outside.

Therefore, in the present embodiment, the control for the operation optimum temperature is performed using the unique phenomenon of the wavelength converter 101. Specifically, two rays of light converted from the excitation light by the parametric fluorescence are used. The parametric fluorescence is self-parametric processing that is converted into light having two low frequencies by excitation light when there is spontaneous emission light (ASE light) from a medium without inputting signal light, and is converted into light having two frequencies satisfying ω₁+ω₂=2ω₀ when excitation light having a frequency 2ω₀ is incident on a second-order non-linear optical medium.

As illustrated in FIG. 3, the optical power of the light converted by the spontaneous parametric processing has wavelength dependency. This means that the gain is different for each wavelength of the signal light, and it is necessary to flatten the gain (gain equalization) in order to use the WDM signal as a device for optical communication that collectively amplifies the WDM signal. Therefore, gain equalization is performed by the GEQ 102. The gain equivalence is processing of discarding excess light at a wavelength with a high gain. In the present embodiment, the excess light is used as the split light from the GEQ 102, the above-described two lights are extracted from the excess light, and the difference therebetween is used for temperature adjustment of the wavelength converter 101. Hereinafter, a specific implementation method thereof will be described. As illustrated in FIG. 1, the light output from the wavelength converter 101 which is a PPLN waveguide is input to the GEQ 102. The GEQ 102 is an optical circuit in which the wavelength dependency of the branching ratio is adjusted to cancel the wavelength dependency of the optical power of the light output from the wavelength converter 101. In the present example, a lattice filter of a planar lightwave circuit in which a Mach-Zehnder interferometer (hereinafter, MZI) is connected in a cascade is used, but an arrayed waveguide grating (hereinafter, AWG), a multimode interference (hereinafter, MMI), an etalon filter, a multilayer film filter, a fiber Bragg grating, a split beam Fourier filter, or the like may be used as long as desired optical characteristics are obtained.

FIG. 4 illustrates the optical power of the optical signal (signal light or conversion light) output from the Through port for each wavelength by the gain equalization processing of the GEQ 102. That is, FIG. 4 illustrates the wavelength dependency of the signal transmittance of the GEQ 102, where the signal transmittance is the above-described optical signal ratio output from the Through port with respect to the optical power of the signal input to the GEQ 102. Therefore, the intensity of light branched as excess light from the cross port of the GEQ 102 increases by the gain equalization processing by the GEQ 102 at a wavelength with high transmittance, and vice versa at a wavelength with low transmittance. For example, the amount of the excess light is large in a valley portion (near 1515 nm and near 1575 nm) having a low transmittance, whereas the amount of excess light is small in a peak portion (1535 nm to 1555 nm) having a high transmittance.

As described above, among the light output from the wavelength converter 101, at a wavelength with a high gain, the branching ratio of the extra light from the cross port increases (transmittance from the Through port is small), and at other portions, the branching ratio decreases. As a result, the light output from the Through port of the GEQ 102 is gain-equalized.

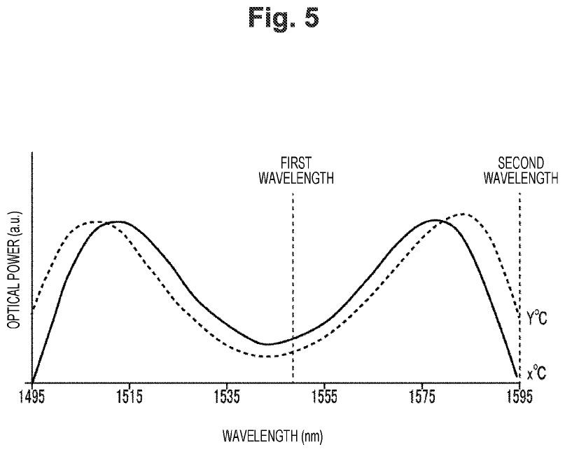

FIG. 5 illustrates the optical power (optical intensity) of the extra light output from the cross port of the GEQ 102 for each wavelength (nm). As can be seen in contrast to the transmittance of the optical signal from the Through port of the GEQ 102 illustrated in FIG. 4, the spectrum of the excess light has peaks at wavelengths corresponding to the troughs of the transmittance in FIG. 4. FIG. 5 illustrates the spectrum of the excess light at two temperatures x° C. (solid line) and y° C. (broken line). As described above with reference to FIG. 3, the spectrum of the transmitted light, that is, the spectrum of the excess light changes in shape depending on the operating temperature of the wavelength converter 101.

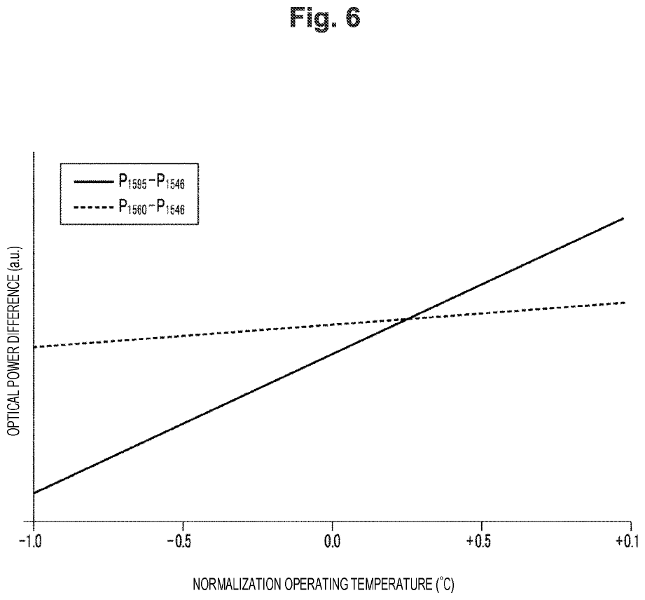

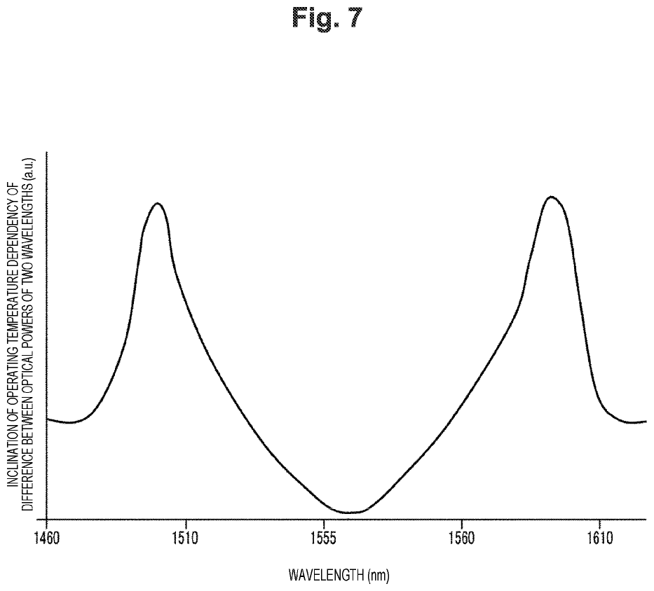

The present embodiment utilizes this change in spectral shape to estimate the operating temperature and feedback the resulting temperature. Specifically, in the present example, light for two wavelengths is extracted and used to estimate the operating temperature of the wavelength converter 101. As illustrated in FIG. 1, the 3 dB coupler 103 is connected to the subsequent stage of the GEQ 102, and the first wavelength separation filter 104a and the second wavelength separation filter 104b, which are bandpass filters, are further connected to the subsequent stage. With this configuration, the excess light of two wavelengths (first wavelength and second wavelength, see FIGS. 4 and 5) is extracted. Two wavelengths to be extracted are selected by the following method. Hereinafter, a case where 1546 nm, which is approximately the center of the wavelength conversion band of the present example, is selected as the first wavelength will be described as an example. In the case of monitoring the optical power of only one wavelength, it is not possible to separate the shape change of the spectrum and the variation in the light intensity of the entire spectrum, and thus, these are separated by the difference between the optical power at the other wavelength. In this case, another wavelength is selected such that the difference between the optical powers of the selected two wavelengths fluctuates more sensitively due to the fluctuation in the operating temperature of the wavelength converter 101. As an example, FIG. 6 illustrates the operating temperature dependency of the wavelength converter 101 of the difference in the optical power from 1546 nm in a case where 1560 nm and 1595 nm are selected as another wavelength. In FIG. 6, the horizontal axis represents the normalized operating temperature (° C.), and the vertical axis represents the optical power difference. As illustrated in the drawing, the inclination of the operating temperature dependency of the difference between the optical powers of 1560 nm and 1546 nm and 1595 nm and 1546 nm is different, and the temperature change is more easily observed as the difference between the optical powers of two wavelengths as the inclination is larger. In the two wavelengths of 1560 nm and 1595 nm described as examples, the operating temperature dependency is larger at 1595 nm, and it can be said that it is suitable for the purpose of the present example. FIG. 7 illustrates the inclination of the operating temperature dependency of the difference between the optical powers of the two wavelengths plotted again for each wavelength. In FIG. 7, the horizontal axis represents the wavelength, and the vertical axis represents the inclination of the operating temperature dependency of the difference between the optical powers of the two wavelengths. It can be seen that the inclination increases at a position close to the top of the peak seen in FIG. 5. From this drawing, another wavelength (second wavelength) is selected as 1595 nm.

FIG. 5 is a diagram for illustrating estimation of a spectrum shape from a difference in optical power between two wavelengths (first wavelength and second wavelength). By acquiring the operating temperature dependency of the difference between the optical powers of 1546 nm and 1595 nm selected above in advance and associating the operating temperature dependency with the voltage value of the photodiode illustrated in FIG. 1, it is possible to perform feedback to the thermoelectric controller so that the operating temperature of the wavelength converter 101 converges to an intended value. In the case of selecting the above two wavelengths, as illustrated in FIG. 6, the lower the operating temperature of the wavelength converter 101, the smaller the difference in optical power, and conversely, the higher the operating temperature, the larger the difference in optical power. In the present example, the difference between the light intensities of the two light intensity detectors is detected via the differentiator 106, calculation is performed by PID control by the controller, and then feedback is performed on the control current of the thermoelectric controller. As a result, the intensity of the wavelength-conversion light can be stabilized within 0.2 dB over the entire band. In the present example, two wavelengths are monitored, but three or more wavelengths may be monitored. In addition, although 1546 nm is selected, the vicinity of the center of the wavelength conversion band is not necessarily selected.

### Effects of Examples

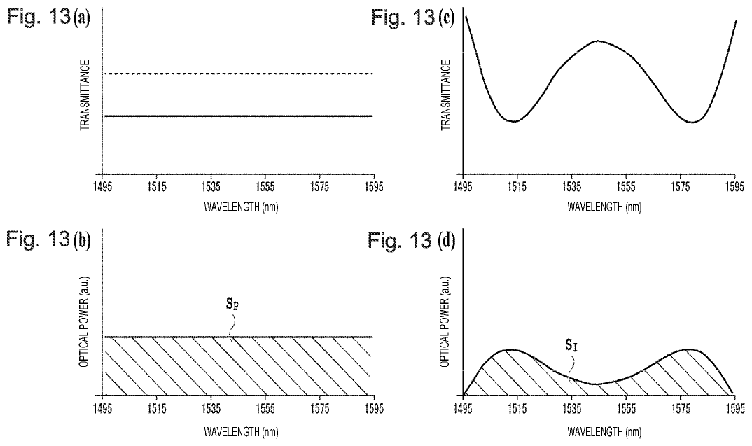

FIGS. 13(a) to 13(d) are diagrams for illustrating effects of the embodiment described above. FIG. 13(a) illustrates a case where temperature control is performed based on light obtained by branching a part of light after wavelength conversion using an optical branch coupler at a subsequent stage of the wavelength converter described in Patent Literature 1, and illustrates transmittance of light (conversion light) from the optical branch coupler. FIG. 13(b) illustrates the optical power of the light branched by the optical branch coupler. As illustrated in these drawings, in the wavelength converter described in Patent Literature 1, since branching is performed using the optical branch coupler, the transmittance of the conversion light is a constant value without depending on the wavelength, and thus the branched light used for temperature control is also a constant value without depending on the wavelength.

On the other hand, as described above, the wavelength converter according to the embodiment of the present invention performs branching of light (excess light) used for temperature control by the GEQ 102 indicating the transmittance in FIG. 13(c). As a result, the optical power of the excess light is as illustrated in FIG. 13(d).

Here, comparing the optical power of light obtained by branching (FIG. 13(b) and FIG. 13(d)), an area Si of the spectrum indicated by hatching of the extra light (FIG. 13(d)) of the present embodiment is smaller (or can be designed to be smaller) than an area Sp of the spectrum indicated by hatching of the optical power (FIG. 13(b)) of Patent Literature 1. As a result, it is possible to suppress an increase in loss of conversion light due to light branched for temperature control.

In addition, in a case where a planar lightwave circuit with a heater is used as the gain equalizer, it is also possible to modify the transmission characteristic of the gain equalizer to absorb the individual difference of the wavelength converter 101. In a case where the PPLN waveguide is used as the wavelength converter 101 as in the present example, the wavelength dependency of the gain slightly differs for each module due to the individual difference of the waveguide width. For example, in a case where the gain equalizer includes a lattice filter, it is possible to adjust transmission characteristics (branching ratio) by driving a heater loaded to each MZI. The transmission characteristics of the gain equalizer can be adjusted to some extent by a heater or the like regardless of whether the gain equalizer is a planar lightwave circuit, but the planar lightwave circuit type gain equalizer has a large degree of freedom in changing the transmission characteristics.

The difference between the light intensities of the two wavelengths described above was detected via the differentiator 106, calculation was performed by PID control by the controller 107, and then feedback was performed on the control current of the thermoelectric controller. As a result, the operating temperature can be adjusted to the optimum point without giving excessive loss to the output light of the non-linear optical element, and the intensity of the wavelength conversion light can be stabilized within 0.2 dB over the entire band.

### Example 2

In Example 1 described above, light of arbitrary two wavelengths is split t from the wavelength converter 101 by the optical branch coupler connected to the output port on one side of the GEQ 102, the first wavelength separation filter 104a, and the second wavelength separation filter 104b. In the present example, a configuration example different from this configuration will be described.

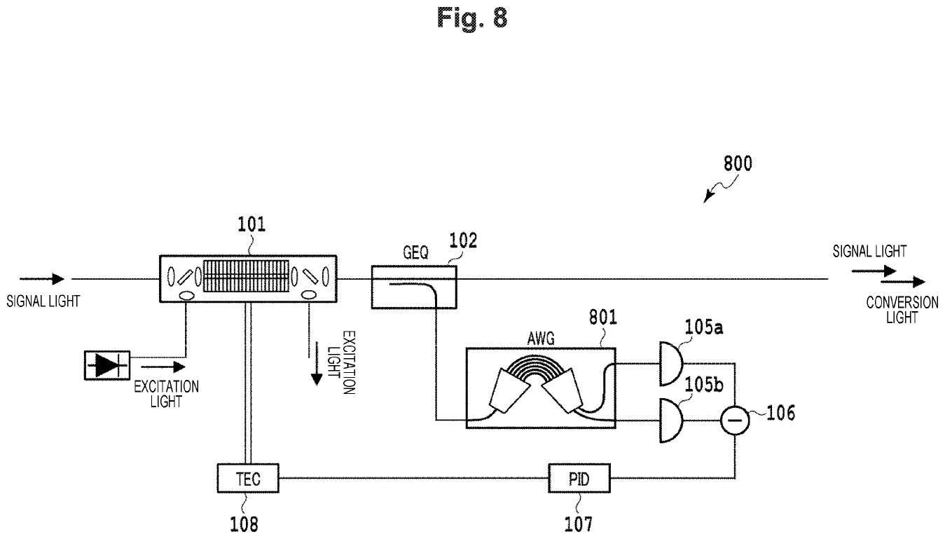

FIG. 8 illustrates a configuration of a wavelength conversion device 800 according to the present example. In the wavelength conversion device 800, the GEQ 102 is connected to the output of the wavelength converter 101, an AWG 801 is connected to the output on one side of the GEQ 102, the first light intensity detector 105a and the second light intensity detector 105b are connected to two output ports of the AWG 801, and the controller (PID) 107 is connected via the differentiator 106. The thermoelectric controller (TEC) 108 is thermally coupled to the wavelength converter 101, and the temperature of the wavelength converter 101 is controlled by a control current from the controller 107.

In the present example, light output from the GEQ 102 is input to the AWG 801 to acquire optical power for two wavelengths used for operating temperature control of the wavelength converter 101. In the example of FIG. 8, the GEQ 102 and the AWG 801 are drawn in different blocks, but these may be integrated into one chip.

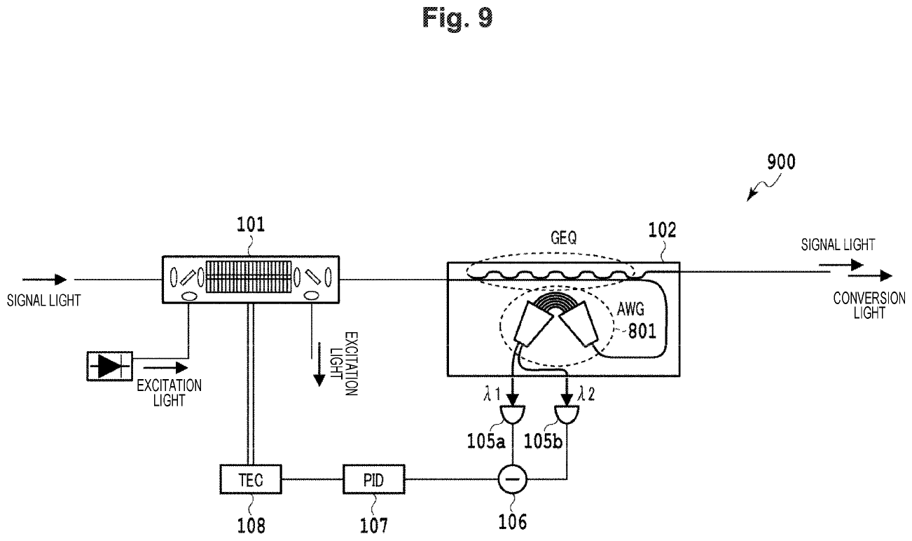

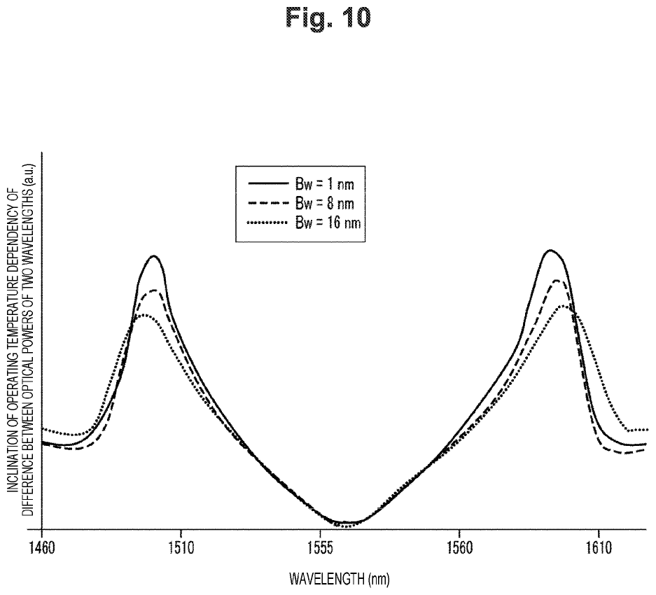

FIG. 9 illustrates a configuration of a wavelength conversion device 900 in which the GEQ 102 and the AWG 801 are integrated on one chip. In the drawing, a lattice filter in which MZIs are cascade-connected in multiple stages is used as the GEQ 102. This configuration can be expected to reduce the footprint of the apparatus body and the mounting cost of the components. The bandwidth of the AWG 801 used in this configuration can be used even at about 1 nm, and when the input optical power to the AWG 801 is weak, the signal-to-noise ratio can be improved by widening the bandwidth of the AWG 801. FIG. 10 illustrates a result of acquiring the inclination of the operating temperature dependency of the difference between the optical powers of two wavelengths while changing the bandwidth of the AWG 801. In FIG. 10, the horizontal axis represents the wavelength, and the vertical axis represents the inclination of the operating temperature dependency of the difference between the optical powers of the two wavelengths. In the same drawing, the graph plots the difference temperature dependence of the light intensity at 1546 nm and the light intensity at each wavelength for each wavelength. As illustrated in the drawing, when the bandwidth of the AWG 801 is changed, the wavelength at which the inclination becomes the largest is shifted, and thus the wavelength to be extracted may be appropriately selected again. In the present example, the difference between 1546 nm and other wavelengths is plotted. However, since the light intensity is weak near the center of the wavelength conversion band and the SN ratio tends to deteriorate when the light intensity is detected by the light receiving element, two wavelengths may be selected by excluding the vicinity of the center of the wavelength conversion band.

The difference between the light intensities of the two wavelengths extracted by the AWG 801 in Example 2 was detected by the differentiator 106, and after calculation by PID control by the controller 107, feedback was performed on the control current of the thermoelectric controller. In the configuration of the present example, by integrating the GEQ 102 and the AWG 801 into one chip, the footprint of the device is greatly reduced, and the number of components is reduced, so that the mounting cost can be greatly reduced. Using the same configuration, the intensity of the wavelength-conversion light over the entire band could be stabilized within 0.2 dB. The wavelength conversion device of the present example can solve the problem that the footprint of the device increases and the mounting cost of the optical branch coupler and the wavelength separation filter occurs.

### Example 3

Since a secondary non-linear optical medium represented by PPLN used in the proposed technique has polarization dependency, a polarization diversity configuration is used in a case where a polarization multiplexed signal is amplified. In this case, it is necessary to make the gains of both polarized waves after amplification uniform using a variable optical attenuator 1103 (hereinafter, VOA) or the like. However, since the attenuation amount of the VOA 1103 needs to be controlled according to each light intensity of the original signal light, there is a problem that the signal light after amplification needs to be partially branched.

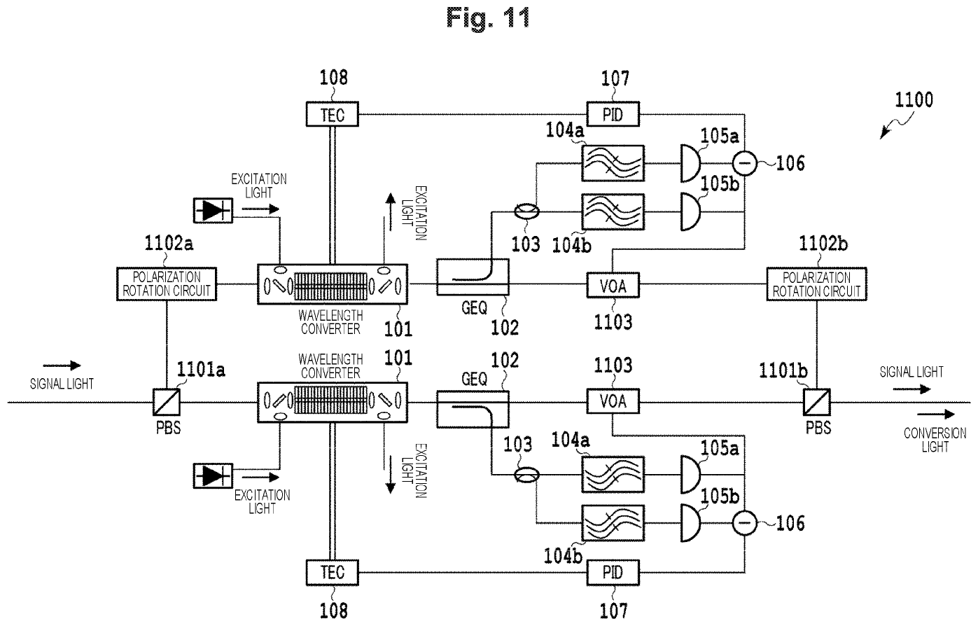

FIG. 11 illustrates a configuration of a wavelength conversion device 1100 according to Example 3 of the present invention. The wavelength conversion device 1100 has a configuration in which two wavelength converters 101 are arranged in parallel, and has a configuration in which a polarizing beam splitter (PBS) 1101a connected to a preceding stage of the wavelength converter 101 and a polarization rotation circuit 1102a are cascade-connected. Furthermore, the GEQ (PLC) 102 is connected to an output of the wavelength converter 101, the optical branch coupler 103 and the VOA 1103 are respectively connected to two outputs of the GEQ 102, and the first wavelength separation filter 104a and the second wavelength separation filter 104b are respectively connected to two outputs of the optical branch coupler. The first light intensity detector 105a and the second light intensity detector 105b are connected to the outputs of the first wavelength separation filter 104a and the second wavelength separation filter 104b, respectively, and the controller (PID) 107 that controls the operating temperature of the wavelength converter 101 and a controller (PID) of the VOA 1103 are connected via the differentiator 106. The thermoelectric controller (TEC) 108 is thermally coupled to the wavelength converter 101, and the temperature of the wavelength converter 101 is controlled by a control current from the controller. The VOA 1103 controls the signal light (conversion light) intensity after amplification based on the signal from at least one light intensity detector. The polarizing beam splitter (PBS) 1101b connected to a subsequent stage of the wavelength converter 101 and the polarization rotation circuit 1102b are cascade-connected.

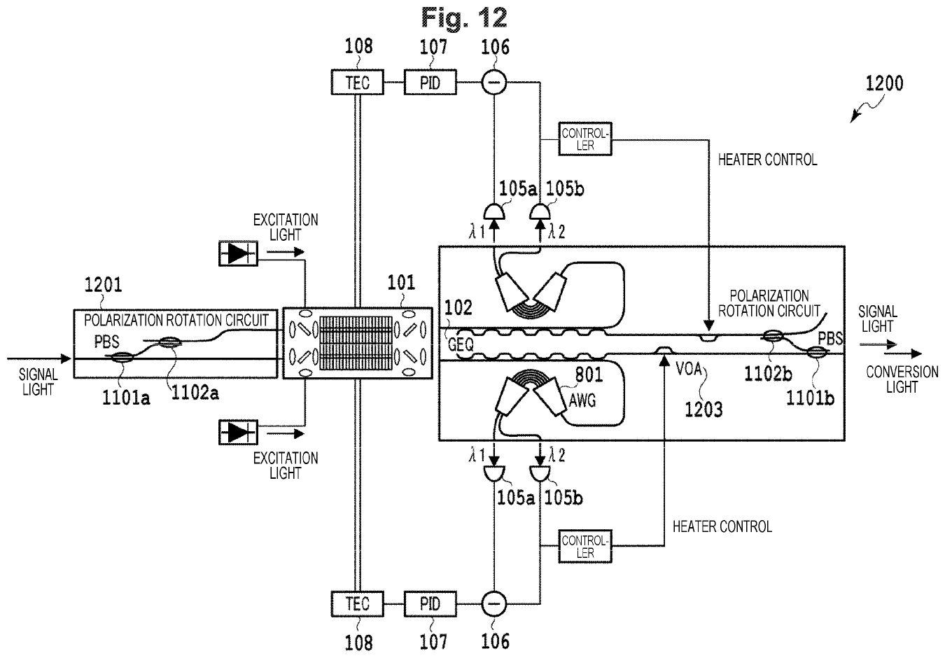

In the configuration of the present example, the input signal light is first separated into a transverse electric field (TE) and a transverse magnetic field (TM) by the PBS 1101a, the TE polarized light is converted into vertically polarized light by the polarization rotation circuit 1102a, and both of the signal light divided into two by the PBS become vertically polarized light. Thereafter, the signal light is amplified and wavelength-converted by the wavelength converter 101, and the amplified signal is input to the GEQ 102 of the PLC to be divided into gain-equalized light and other light. The light intensity corresponding to two wavelengths is acquired from the other light branched by the GEQ 102 by the first wavelength separation filter 104a, the second wavelength separation filter 104b, the first light intensity detector 105a, and the second light intensity detector 105b, and the operating temperature of the wavelength converter 101 is controlled based on a difference between these light intensities. In this configuration, in addition, the light intensity of gain-equalized light is estimated from at least one of the light intensities of the two wavelengths, and the attenuation amount of the VOA 1103 is controlled. In the GEQ 102, since the light is divided into at least two paths at a predetermined branching ratio, it is possible to estimate the level (light intensity) of the entire original signal light from the intensity of one light. Therefore, the original signal light intensity can be estimated by the light discarded by the GEQ 102, and it is not necessary to separately branch the monitor light for controlling the VOA 1103 using the discarded light. This makes it possible to avoid excessive loss. In FIG. 11, the power of light of two wavelengths is detected using the optical branch coupler 103 and the band pass filter that is the first wavelength separation filter 104a and the second wavelength separation filter 104b, but the AWG 801 or the like may be used as illustrated in Example 2. In addition, the GEQ 102, the first wavelength separation filter 104a, the second wavelength separation filter 104b, the VOA 1203, and the like can be integrated in one chip by being realized by a planar lightwave circuit. In addition, although not illustrated in the configuration diagram, a delay line may be connected to a subsequent stage of the GEQ 102. FIG. 12 illustrates a configuration of a wavelength conversion device 1200 in which a planar lightwave circuit 1201 in which the PBS 1101a and the polarization rotation circuit 1102a are integrated is connected to a preceding stage of the wavelength converter 101, and a planar lightwave circuit in which the GEQ 102, the first wavelength separation filter 104a, the second wavelength separation filter 104b, the VOA 1203, the polarization rotation circuit 1102b, and the PBS 1101b are integrated is connected to a subsequent stage. In this configuration, a lattice filter is used for the GEQ 102, and the attenuation amount of the VOA 1203 connected to the subsequent stage of the GEQ 102 is controlled using the intensity of the discarded light branched by the GEQ 102. In this configuration, since the optical circuit is configured without using a fiber component or the like, the delay time can be easily adjusted by providing the delay line in both or one of the arms to which the polarized waves are input. With this configuration, it can be expected to reduce the footprint of the device main body and the mounting cost of the components, and the intensity of the wavelength conversion light can be stabilized within 0.2 dB over the entire band.

1. A wavelength conversion device provided with a wavelength converter using a non-linear optical medium, and a controller that controls a temperature of the wavelength converter, the wavelength conversion device comprising:
an input port to which signal light and excitation light are input, at a preceding stage of the wavelength converter;
a gain equalizer having at least one input port and two or more output ports connected to a subsequent stage of the wavelength converter; and
a light intensity detector connected to the gain equalizer, wherein
light output from the wavelength converter is input to the gain equalizer, and after the light is split into gain-equalized light and other light, the split other light is measured by the light intensity detector, and the temperature of the wavelength converter is controlled based on the detected light intensity.

2. The wavelength conversion device according to claim 1, the wavelength conversion device further comprising:
an optical branch coupler at a subsequent stage of the gain equalizer;
at least two wavelength separation filters at a subsequent stage of the optical branch coupler; and
a light intensity detector that detects the light separated by at least the wavelength separation filter, wherein
light of at least two wavelengths is separated from the light branched by the gain equalizer using the wavelength separation filter, respective light intensities are detected by the light intensity detector, and a temperature of the wavelength converter is controlled based on a difference between the light intensities of the two wavelengths.

3. The wavelength conversion device according to claim 1, wherein the two wavelengths are selected from a wavelength conversion band of the wavelength converter such that a difference between light intensities at the respective wavelengths varies depending on an operating temperature of the wavelength converter.

4. The wavelength conversion device according to claim 2, the device further comprising:
a variable optical attenuator at a preceding stage or a subsequent stage of the gain equalizer, wherein
light of at least one wavelength is separated from the light branched by the gain equalizer using the wavelength separation filter, each light intensity is detected by the light intensity detector, and an attenuation amount of the variable optical attenuator is controlled based on the light intensity of the at least one wavelength.

5. The wavelength conversion device according to claim 1, wherein the gain equalizer includes an etalon filter, a multi-layer filter, a fiber Bragg grating, a planar lightwave circuit, and a split-beam Fourier filter.

6. The wavelength conversion device according to claim 5, wherein the planar lightwave circuit includes a lattice filter in which a plurality of directional couplers, multimode interferometers, and Mach-Zehnder interferometer are cascade-connected, an arrayed waveguide grating, and a combination thereof.

7. The wavelength conversion device according to claim 1, wherein the gain equalizer includes a planar lightwave circuit, and is configured to modulate a refractive index of a waveguide included in the planar lightwave circuit by a heater loaded in the planar lightwave circuit, and the heater is driven to adjust circuit characteristics to absorb individual differences in a gain characteristic of the wavelength converter.

8. The wavelength conversion device according to claim 1, further comprising:
a planar lightwave circuit in which a lattice filter and an arrayed waveguide grating are cascade-connected at the subsequent stage of the wavelength converter; and
at least two light intensity detectors connected to at least two output ports of the arrayed waveguide grating, wherein
a temperature of the wavelength converter is controlled based on a difference between light intensities detected by the at least two light intensity detectors.

9. The wavelength conversion device according to claim 1 having a polarization diversity configuration including a polarization separation/merging circuit and a polarization rotation circuit that performs polarization rotation between a transverse magnetic field and a transverse electric field, the wavelength conversion device comprising:
the wavelength conversion device in each path through which a horizontally polarized wave and a vertically polarized wave after a polarization separation propagate; and
a variable optical attenuator in both or one of path through which the horizontally polarized wave and the vertically polarized wave propagate, wherein
the variable optical attenuator is controlled based on light intensity of light branched by a gain equalizer.

10. The wavelength conversion device according to claim 1, wherein the non-linear optical medium contains LiNbO₃, LiTaO₃, LiNb(x)Ta(1-x)O3 (0≤x≤1), or at least one selected from the group consisting of Mg, Zn, Sc, and In as an additive.
